(19) United States
(12) Patent Application Publication
(10) Pub. No.: US 2024/0213494 A1
(43) Pub. Date: Jun. 27, 2024

(54) CURRENT COLLECTOR FOR BATTERY AND METHOD FOR FABRICATING THE SAME

(71) Applicant: THE HONG KONG POLYTECHNIC UNIVERSITY, Hong Kong (CN)

(72) Inventors: Zijian ZHENG, Hong Kong (CN); Jian SHANG, Hong Kong (CN)

(21) Appl. No.: 18/557,621

(22) PCT Filed: Apr. 29, 2021
(86) PCT No.: PCT/CN2021/090844

§ 371 Date: Oct. 27, 2023

(51) Int. Cl. H01M 4/66; H01M 4/04; H01M 4/131; H01M 4/74; H01M 50/141; H01M 50/491

(52) U.S. Cl. CPC H01M 4/661; H01M 4/0404; H01M 4/131; H01M 4/667; H01M 4/747; H01M 50/141; H01M 50/491

(57) ABSTRACT

The present disclosure provides an ultrathin and superlight glass-fiber based current collector enabling energy-dense flexible batteries, and a method for fabricating the current collector. This current collector includes a metal-coated glass-fiber fabric having metal-coated glass fibers, and the metal-coated glass fiber includes a surface-modified glass fiber covered by one or two metal layers.

### TECHNICAL FIELD

The present invention relates to a current collector for a battery, and more particularly, to a glass-fiber based current collector and a method for fabricating the same.

### BACKGROUND

Flexible batteries (FBs) are indispensable energy storage devices for future wearable applications including wearable displays, health-care sensors, portable devices, and smart textiles. In the past decade, significant progress has been made in the design of materials, fabrications and assembles in FBs. However, the commercial implementation of FBs is still plagued because of their poor energy densities. The major obstacle to realize high energy density is the lack of ultrathin and superlight flexible current collectors. The weight and thickness of widely used soft current collectors (i.e., conductive fabrics, papers, and polymer substrates) are 1-5 folds larger than that of metal foils used in rigid-type batteries, thus leading poor energy densities of FBs. Therefore, the development of superlight and ultrathin current collectors with high flexibility and mechanical stability is important.

Currently, intensive research work focus on developing/modifying various conductive soft substrates, including graphene substrates, CNT papers, non-woven carbons, ultrathin conductive polymers, flexible metal foils, et al. These novel soft substrates are thin and lightweight, which improve the energy density and enrich the kinds of FBs, simultaneously. However, when applied to practical applications, these designed substrates are usually limited in costs, chemical stabilities, mechanical durability, and scalabilities. For instant, CNT and graphene based soft substrates hold nearly 1-3 orders of magnitude higher price than metal foils, conductive polymer substrates always suffer from side reaction with lithium ions, and flexible metal foils usually show poor mechanical flexibilities. Besides, most of state-of-the-art design of soft current collectors (e.g., metal/polymer substrate, metal/fabric substrates) for FBs are always involved with high-cost technologies such as sputtering and evaporation, which increase both the costs and the difficulties for scale-up fabrications. Up until now, there is no report of flexible current collectors that meet all the requirements of weight, thickness, flexibilities, costs, and scale-up fabrications.

A need therefore exists for an improved current collector to fulfil high-energy-density requirements of FBs.

### SUMMARY

The present disclosure provides ultrathin and superlight glass-fiber based current collectors enabling energy-dense flexible batteries and methods for fabricating the same.

Provided herein is a current collector for an anode comprising: a metal-coated glass-fiber fabric comprising metal-coated glass fibers, each metal-coated glass fiber comprising: a surface-modified glass fiber comprising a glass fiber, poly[2-(methacryloyloxy)ethyl]trimethyl ammonium chloride (PMETAC) brushes and palladium (Pd) metal, wherein the PMETAC brushes are loaded with the palladium metal and coated on a surface of the glass fiber; and a first metal layer coated on the surface-modified glass fiber such that the PMETAC brushes loaded with the palladium metal are embedded in the first metal layer and the first metal layer is in contact with the surface of the glass fiber, the first metal layer being a copper layer, a silver layer or a gold layer.

In certain embodiments, the first metal layer is a copper layer; and the metal-coated glass-fiber fabric further comprises a second metal layer coated on the copper layer such that the copper layer is sandwiched between the second metal layer and the glass fiber, the second metal layer being a silver layer or a gold layer.

In certain embodiments, the first metal layer is a silver layer; and the metal-coated glass-fiber fabric further comprises a gold layer coated on the silver layer such that the silver layer is sandwiched between the gold layer and the glass fiber.

In certain embodiments, the first metal layer has a thickness between 50 nm and 500 nm.

In certain embodiments, the second metal layer has a thickness between 20 nm and 50 nm.

In certain embodiments, the metal-coated glass-fiber fabric has a plain weaving structure, a thickness between 30 μm and 100 μm, and a mass density between 4 mg/cm² and 15 mg/cm²; and the glass fiber comprises silica and aluminum oxide and has a diameter between 0.1 μm and 30 μm.

Provided herein is a method for fabricating the metal-coated glass-fiber fabric of the current collector described above comprising: providing a glass-fiber fabric comprising glass fibers; introducing a hydroxyl (OH) group on each glass fiber by plasma treatment thereby forming plasma-treated glass fibers; modifying the surface of each plasma-treated glass fiber with double-bond-containing silane molecules by silanization thereby forming silanized glass fibers; coating each silanized glass fiber with PMETAC brushes by in-situ polymerization thereby forming PMETAC-coated glass fibers; loading tetrachloropalladate ions ([PdCl₄]²⁻) to the PMETAC brushes by ion exchange thereby forming [PdCl₄]²⁻-load glass fibers; reducing the [PdCl₄]²⁻ to Pd metal thereby forming Pd-loaded glass fibers; and coating each Pd-load glass fiber with a first metal layer by electroless deposition thereby forming the metal-coated glass fibers, the first metal layer being a copper layer, a silver layer, or a gold layer.

Provided herein is a method for fabricating the metal-coated glass-fiber fabric of the current collector described above comprising: providing a glass-fiber fabric comprising glass fibers; introducing a hydroxyl (OH) group on each glass fiber by plasma treatment thereby forming plasma-treated glass fibers; modifying the surface of each plasma-treated glass fiber with double-bond-containing silane molecules by silanization thereby forming silanized glass fibers; coating each silanized glass fiber with PMETAC brushes by in-situ polymerization thereby forming PMETAC-coated glass fibers; loading tetrachloropalladate ions ([PdCl₄]²⁻) to the PMETAC brushes by ion exchange thereby forming [PdCl₄]²⁻-load glass fibers; reducing the [PdCl₄]²⁻ to Pd metal thereby forming Pd-loaded glass fibers; coating each Pd-load glass fiber with a copper metal layer by electroless deposition thereby forming the copper-coated glass fibers; and coating each copper-coated glass fiber with a silver layer or a gold layer thereby forming the metal-coated glass-fiber fabric.

Provided herein is a flexible anode comprising the current collector described above and an anode material coated on and/or within the metal-coated glass-fiber fabric.

In certain embodiments, the anode material is lithium, natural graphite, artificial graphite, hard carbon, silicon, a silicon and carbon composite, or lithium titanate (Li₄Ti₅O₁₂).

Provided herein is a current collector for a cathode comprising: a metal-coated glass-fiber fabric comprising metal-coated glass fibers, each metal-coated glass fiber comprising: a surface-modified glass fiber comprising a glass fiber, poly[2-(methacryloyloxy)ethyl]trimethyl ammonium chloride (PMETAC) brushes and palladium metal, wherein the PMETAC brushes are loaded with the palladium metal and coated on the surface of the glass fiber; and a metal layer coated on the modified surface of the surface-modified glass fiber such that the PMETAC brushes loaded with the palladium metal are embedded in the metal layer and the metal layer is in contact with a surface of the glass fiber, the metal layer being a nickel layer, an aluminum layer or a titanium layer.

In certain embodiments, the metal layer has a thickness between 100 nm and 500 nm.

In certain embodiments, the metal-coated glass-fiber fabric has a plain weaving structure, a thickness between 30 μm and 100 μm, and a mass density between 4 mg/cm² and 16 mg/cm²; and the glass fiber comprises silica and aluminum oxide and has a diameter between 0.1 μm and 30 μm.

Provided herein is a method for fabricating the metal-coated glass-fiber fabric of the current collector described above comprising: providing a glass-fiber fabric comprising glass fibers; introducing a hydroxyl (OH) group on each glass fiber by plasma treatment thereby forming plasma-treated glass fibers; modifying the surface of each plasma-treated glass fiber with double-bond-containing silane molecules by silanization thereby forming silanized glass fibers; coating each silanized glass fiber with PMETAC brushes by in-situ polymerization thereby forming PMETAC-coated glass fibers; loading tetrachloropalladate ions ([PdCl₄]²⁻) to the PMETAC brushes by ion exchange thereby forming [PdCl₄]²⁻-load glass fibers; reducing the [PdCl₄]²⁻ to Pd metal thereby forming Pd-loaded glass fibers; and coating each Pd-load glass fiber with a metal layer by electroless deposition thereby forming the metal-coated glass-fiber fabric, the metal layer is a nickel layer, an aluminum layer or a titanium layer.

In certain embodiments, the glass-fiber fabric has a thickness between 30 μm and 100 μm, and a mass density between 3 mg/cm² and 12 mg/cm²; and the metal-coated glass-fiber fabric has a mass density between 4 mg/cm² and 16 mg/cm².

Provided herein is a flexible cathode comprising the current collector described above and a cathode material coated on and/or within the metal-coated glass-fiber fabric.

In certain embodiments, the cathode material is lithium manganese oxide (LMO), lithium iron phosphate (LFP), LiNi_{0.5}Mn_{1.5}O₄ (LNMO), lithium nickel cobalt manganese oxide (NCM), lithium nickel cobalt aluminum oxides (NCA), Lithium cobalt oxide (LCO) or sulfur (S).

Provided herein is a flexible battery comprising: the flexible anode described above and the flexible cathode described above; a separator; and an electrolyte.

In certain embodiments, the anode material is lithium; the cathode material is LNMO; the separator is a microporous monolayer polypropylene (PP) membrane; and the electrolyte is lithium hexafluorophosphate (LiPF₆) in dimethyl carbonate (DEC) and fluoroethylene carbonate (FEC).

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 is a schematic diagram depicting an anode according to certain embodiments;

FIG. 2 is a flow chart depicting a method for fabricating an anode according to certain embodiments;

FIG. 3 is a schematic diagram depicting a method for fabricating a metal-coated glass-fiber fabric for an anode according to certain embodiments;

FIG. 4 is a schematic diagram depicting a cathode according to certain embodiments;

FIG. 5 is a flow chart depicting a method for fabricating a cathode according to certain embodiments;

FIG. 6 is a schematic diagram depicting a method for fabricating a metal-coated glass-fiber fabric for a cathode according to certain embodiments;

FIG. 7A is schematic illustration for the fabrication process of conductive glass-fiber fabric (GF), GF-based anode and cathode composites and flexible battery according to certain embodiments;

FIG. 7B is a digital image of GF-based current collector of silver and copper co-coated glass-fiber fabric (AgCuGF);

FIG. 7C is the XRD pattern of AgCuGF;

FIG. 7D shows SEM images of AgCuGF, indicating the Ag and Cu are uniformly coated on the glass fiber, which makes the fabric conductive;

FIG. 7E is a digital image of GF-based current collector of nickel-coated glass-fiber fabric (NiGF);

FIG. 7F is the XRD pattern of NiGF;

FIG. 7G shows SEM images of NiGF;

FIG. 7H shows the resistance changes with increasing of bending cycles at a bending radius of 2 mm and frequency of 0.25 Hz;

FIG. 7I shows the resistance changes with increasing of folding cycles;

FIG. 7J shows comparison in tensile strain and stress of GF-based current collectors (including AgCuGF and NiGF) with commercial cotton fabric, carbon fabric, carbon felt and carbon paper;

FIG. 7K shows comparison in mass density and thickness of GF-based current collectors (AgCuGF and NiGF) with commercial used current collectors (Cu foil and Al foil), and most widely used soft substrates including graphene paper, CNT paper, non-woven carbon paper, and carbon fabric;

FIG. 8A is the digital image of Li-Metal composite anode (Li/AgCuGF) with areal capacity of 6 mAh cm⁻² of lithium;

FIG. 8B is the SEM image showing top-down view of Li/AgCuGF anode composite;

FIG. 8C is the cross-section SEM image of Li/AgCuGF anode composite;

FIG. 8D shows the deposition voltage of lithium on various substrates (Cu Foil, CuGF and AgCuGF) at deposition current of 0.1 mA cm⁻²;

FIG. 8E shows the Li plating and striping on various substrates (Cu Foil, CuGF and AgCuGF) versus time;

FIG. 8F shows the Li plating and striping on various substrates (Cu Foil, CuGF and AgCuGF) versus areal capacity and calculated coulombic efficiencies;

FIG. 8G shows galvanostatic plating and stripping profiles in Li/AgCuGF composite, Li/CuGF composite, Li/Cu foil composite, and Li foil symmetric cells at 1 mA cm⁻²;

FIG. 8H shows the plating and striping profiles of various symmetric cell at the 1^{st}, 10^{th}, 25^{th}, 50^{th}, 75^{th}, and 100^{th} cycle;

FIG. 9A shows the weight comparison of full batteries using a graphite/Cu anode, Li/Cu anode and Li/AgCuGF anode, by using Li/AgCuGF composite anode, the weight of total electrode will decrease about 25% when compared with commercial used graphite/Cu anode;

FIG. 9B shows comparison of designed flexible LBs using Li/AgCuGF anode with commercial Li-ion battery;

FIG. 9C shows the cycling performance of the Li/AgCuGFllLNMO/NiGF flexible battery;

FIG. 9D shows the voltage profile of the 1^{st}, 20^{th}, 100^{th}, 200^{th}, 250^{th} and 300^{th} cycle of the Li/AgCuGFllLNMO/NiGF flexible battery;

FIG. 9E shows the cycling performance of the Li/AgCuGFllLFP/Al battery;

FIG. 9F shows the voltage profile of the 1^{st}, 20^{th}, 100^{th}, and 250^{th} cycle of the Li/AgCuGFllLFP/Al battery;

FIG. 9G shows the cycling performance of the Li/AgCuGFllNCM532/Al battery;

FIG. 9H shows the voltage profile of the 1^{st}, 20^{th}, and 100^{th} cycle of the Li/AgCuGFllNCM532/Al battery;

FIG. 10A shows the resistance changes with increasing of bending cycles at a bending radius of 2 mm and frequency of 0.25 Hz of bending performance of Li/AgCuGF composite anode;

FIG. 10B shows the resistance changes with increasing of bending cycles at a bending radius of 2 mm and frequency of 0.25 Hz of bending performance of LNMO/NiGF composite cathode;

FIG. 10C shows the areal capacity changes of GF-based flexible LBs at different bending angels (0°, 45°, 90°, 135°, and 180°);

FIG. 10D shows the areal capacity retention of GF-based flexible LBs with device area of 6.5 cm² under continuous bending at a curvature radius of 10 mm and 5 mm and a bending frequency of 0.25 Hz;

FIG. 10E shows the charge-discharge profile before and after 1000 continuous bending;

FIG. 11A shows the digital images of the GF-based electrodes and flexible LBs assembled using GF-based electrodes;

FIG. 11B shows the voltage changes of GF-based flexible LBs at different bending angels (0°, 45°, 90°, 135°, and 180°);

FIG. 11C shows the demonstration of GF-based flexible LBs powering LED garment at different bending angels (0°, 90°, 135°, and 180°); and

FIG. 12 shows anode formation for coulombic efficiency calculation.

Skilled artisans will appreciate that elements in the figures are illustrated for simplicity and clarity and have not necessarily been depicted to scale.

### DETAILED DESCRIPTION OF THE INVENTION

It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

The present disclosure provides a current collector being a superlight and ultrathin conductive fabric with excellent chemical stability and mechanical softness, which simultaneously realize high energy density and mechanical flexibility for flexible batteries e.g., flexible lithium battery (LB).

Provided herein is a current collector for an anode comprising: a metal-coated glass-fiber fabric comprising metal-coated glass fibers, each metal-coated glass fiber comprising: a surface-modified glass fiber comprising a glass fiber, poly[2-(methacryloyloxy)ethyl]trimethyl ammonium chloride (PMETAC) brushes and palladium (Pd) metal, wherein the PMETAC brushes are loaded with the palladium metal and coated on a surface of the glass fiber; and a first metal layer coated on the surface-modified glass fiber such that the PMETAC brushes loaded with the palladium metal are embedded in the first metal layer and the first metal layer is in contact with the surface of the glass fiber, wherein the first metal layer is a copper layer, a silver layer or a gold layer.

In certain embodiments, the first metal layer is a copper layer; and the metal-coated glass-fiber fabric further comprises a second metal layer coated on the copper layer such that the copper layer is sandwiched between the second metal layer and the glass fiber, wherein the second metal layer is a silver layer or a gold layer. The second metal layer can be coated by electroless deposition (ELD) or electrodeposition. The second metal layer can improve coulombic efficiency and cycle stability of the anode.

In certain embodiments, the first metal layer is a silver layer; and the metal-coated glass-fiber fabric further comprises a gold layer coated on the silver layer such that the silver layer is sandwiched between the gold layer and the glass fiber.

In certain embodiments, the first metal layer has a thickness between 50 nm and 500 nm. In certain embodiments, the second metal layer has a thickness between 20 nm and 50 nm.

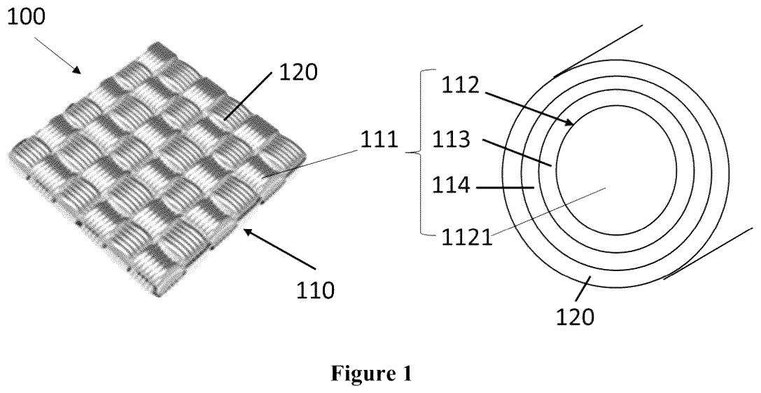

FIG. 1 is a schematic diagram depicting an anode 100 according to certain embodiments. The anode 100 comprises a metal-coated glass-fiber fabric 110 (i.e., a current collector) and an anode material 120. The metal-coated glass-fiber fabric 110 comprises metal-coated glass fibers 111. Each metal-coated glass fiber 111 comprises a surface-modified glass fiber 112, a copper layer 113 and a silver layer 114. The surface-modified glass fiber 112 comprises a glass fiber 1121, poly[2-(methacryloyloxy)ethyl]trimethyl ammonium chloride (PMETAC) brushes and palladium metal. The surface of the glass fiber 1121 is modified with the PMETAC brushes loaded with the palladium metal by coating the PMETAC brushes on the surface of the glass fiber 1121. The copper layer 113 is coated on and fully covers the surface-modified glass fiber 112 fiber such that the PMETAC brushes loaded with the palladium metal are embedded in the copper layer 113 and the copper layer 113 is in contact with the surface of the glass fiber 1121 for providing better adhesion and conductivity. The silver layer 114 is coated on the copper layer 113 such that the copper layer 113 is sandwiched between the glass fiber 1121 and the silver layer 114. The anode material 120 is coated on the exterior surface of the silver layer 114.

As the surface of glass-fiber fabric is smooth, it is difficult for depositing metal thereon to make it conductive. In addition, since the surface of glass-fiber fabric is hydrophobic, conventional metal deposition method may merely coat a thin layer metal on glass-fiber fabric, but it is easy to peel off and cannot used as a stable current collector. Accordingly, this embodiment provides a surface-modified glass fiber including a glass fiber, PMETAC brushes and palladium metal, and the surface of the glass fiber is modified with the PMETAC brushes loaded with the palladium metal, such that a thicker copper layer can be formed on the glass fiber with high adhesion for avoiding peeling off of the copper layer enabling the metal-coated glass-fiber fabric to be a stable current collector with high conductivity.

This embodiment further provides a double-layer design with an intermediate copper layer as a conductive layer and a silver layer as a functional layer. The copper layer makes the glass-fiber fabric conductive, and the silver layer can react with lithium ions during the lithium deposition process to form Li—Ag alloy. The alloy forming reaction can guide lithium ions uniformly deposited on the current collectors, which enables high coulombic efficiency and long cycle stability of Li/AgCuGF composite anode.

In certain embodiments, the glass fiber comprises silica and aluminum oxide, and has a diameter between 0.1 μm and 30 μm, between 4 μm and 6 μm, or about 5 μm.

In certain embodiments, the copper layer has a thickness between 50 nm and 500 nm, between 200 nm and 300 nm, or about 250 nm.

In certain embodiments, the silver layer has a thickness between 20 nm and 50 nm, or about 35 nm. In certain embodiments, the silver layer fully or partially covers the copper layer.

In certain embodiments, the metal-coated glass-fiber fabric has a plain weaving structure, a thickness between 30 μm and 100 μm, and a mass density between 4 mg/cm² and 15 mg/cm². The plain weaving structure weaving can provide good dimensional stability of high fabric counts. However, other weaving structure can also be used.

In certain embodiments, the anode material is lithium, natural graphite, artificial graphite, hard carbon, silicon, a silicon and carbon composite, or lithium titanate (Li₄Ti₅O₁₂).

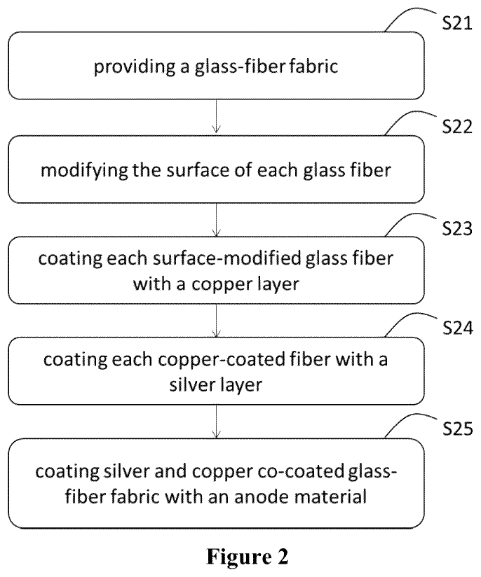

FIG. 2 is a flow chart depicting a method for fabricating an anode according to certain embodiments. The current collector of the anode is a silver and copper co-coated glass-fiber fabric. In step S21, a glass-fiber fabric comprising glass fibers is provided. In step S22, the surface of each glass fiber is modified with PMETAC brushes loaded with Pd metal (e.g., Pd particles) thereby forming a surface-modified glass-fiber fabric with surface-modified glass fibers. In step S23, each surface-modified glass fiber is coated with a copper layer thereby forming a copper-coated glass-fiber fabric with copper-coated glass fibers. In step S24, each copper-coated glass fiber is coated with a silver layer thereby forming the silver and copper co-coated glass-fiber fabric with silver and copper co-coated glass fibers. In step S25, the silver and copper co-coated glass-fiber fabric is further coated with an anode material thereby forming the anode.

In certain embodiments, the glass-fiber fabric has a thickness between 30 μm and 100 μm, and a mass density between 3 mg/cm² and 12 mg/cm²; each surface-modified glass fiber is coated with the copper layer by electroless deposition; each copper-coated glass fiber is coated with the silver layer by electroless deposition; and the metal-coated glass-fiber fabric has a thickness between 30 μm and 100 μm, and a mass density between 4 mg/cm² and 15 mg/cm².

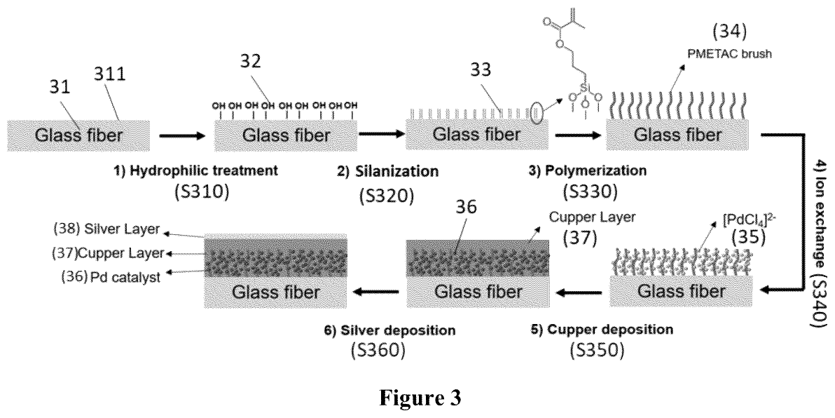

FIG. 3 is a schematic diagram depicting a method for fabricating a metal-coated glass-fiber fabric for an anode according to certain embodiments. In step S310, a hydroxyl (OH) group 32 is introduced on a glass fiber 31 by plasma treatment thereby forming a plasma-treated glass fiber. In step S320, the surface of the plasma-treated glass fiber is modified with double-bond-containing silane molecules 33 by silanization thereby forming a silanized glass fiber. In step S330, the silanized glass fiber is coated (or grafted) with PMETAC brushes 34 by in-situ polymerization thereby forming a PMETAC-coated glass fiber. This polymerization process ensure the good adhesion between the glass fiber 31 and a copper layer 37 to be coated. In step S340, tetrachloropalladate ions ([PdCl₄]²⁻) 35 are loaded to the PMETAC brushes 34 by ion exchange thereby forming a [PdCl₄]²⁻-load glass fiber. The [PdCl₄]²⁻ loading process makes sure the existence of reduction catalyst for copper deposition. In step S350, the [PdCl₄]²⁻ 35 are reduced to Pd particles 36 (i.e., a catalyst) thereby forming a Pd-loaded glass fiber, and the Pd-load glass fiber is coated with a copper layer 37 by copper deposition such that the PMETAC brushes 34 loaded with Pd metal 36 are embedded in the copper layer 37 and the copper layer 37 is in contact with the surface 311 of glass fiber 31 for providing better adhesion and conductivity, thereby forming a copper-coated glass fiber. In step S360, the copper-coated glass fiber is coated with a silver layer 38 by silver deposition (e.g., electroless deposition or electrodeposition) thereby forming the metal-coated glass-fiber fabric.

Provided herein is a current collector for a cathode comprising: a metal-coated glass-fiber fabric comprising metal-coated glass fibers, each metal-coated glass fiber comprising: a surface-modified glass fiber comprising a glass fiber, poly[2-(methacryloyloxy)ethyl]trimethyl ammonium chloride (PMETAC) brushes and palladium metal, wherein the PMETAC brushes are loaded with the palladium metal and coated on the surface of the glass fiber thereby forming a modified surface of the surface-modified glass fiber; and a metal layer coated on the modified surface of the surface-modified glass fiber such that the PMETAC brushes loaded with the palladium metal are embedded in the metal layer and the metal layer is in contact with the surface of the glass fiber, wherein the metal layer is a nickel layer, an aluminum layer or a titanium layer.

In certain embodiments, the metal layer has a thickness between 100 nm and 500 nm.

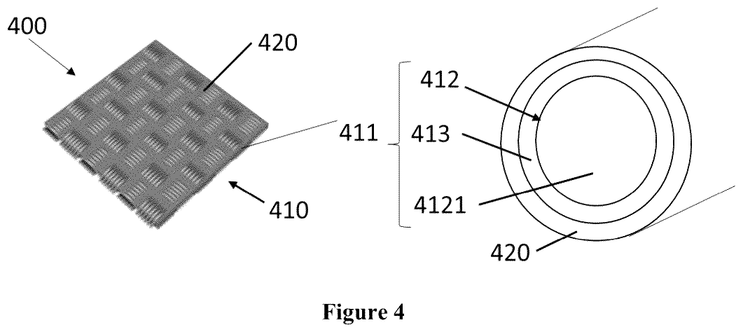

FIG. 4 is a schematic diagram depicting a cathode 400 according to certain embodiments. The cathode 400 comprises a metal-coated glass-fiber fabric 410 (i.e., a current collector) and a cathode material 420. The metal-coated glass-fiber fabric 410 comprises metal-coated glass fibers 411. Each metal-coated glass fiber 411 comprises a surface-modified glass fiber 412 and a nickel layer 413. The surface-modified glass fiber 412 comprises a glass fiber 4121, PMETAC brushes and Pd metal. The surface of the glass fiber 4121 is modified with the PMETAC brushes loaded with the palladium metal by coating the PMETAC brushes on the surface of the glass fiber 4121. The nickel layer 413 is coated on and fully covers the surface-modified glass fiber 412 fiber such that the PMETAC brushes loaded with the palladium metal are embedded in the nickel layer 413 and the nickel layer 413 is in contact with the surface of the glass fiber 4121 for providing better adhesion and conductivity. The cathode material 420 is coated on the exterior surface of the nickel layer 412.

In certain embodiments, the glass fiber comprises silica and aluminum oxide and has a diameter between 0.1 μm and 30 μm, between 4 μm and 6 μm, or about 5 μm.

In certain embodiments, the nickel layer has a thickness between 100 nm and 500 nm, between 300 nm and 400 nm, or about 350 nm.

In certain embodiments, the nickel layer is replaced by an aluminum layer or a titanium layer.

In certain embodiments, the metal-coated glass-fiber fabric has a plain weaving structure, a thickness between 30 μm and 100 μm, and a mass density between 4 mg/cm² and 16 mg/cm².

In certain embodiments, the cathode material is lithium manganese oxide (LMO), lithium iron phosphate (LFP), LiNi_{0.5}Mn_{1.5}O₄(LNMO) or lithium nickel cobalt manganese oxide (NCM), lithium nickel cobalt aluminum oxides (NCA) or Lithium cobalt oxide (LCO) or sulfur (S).

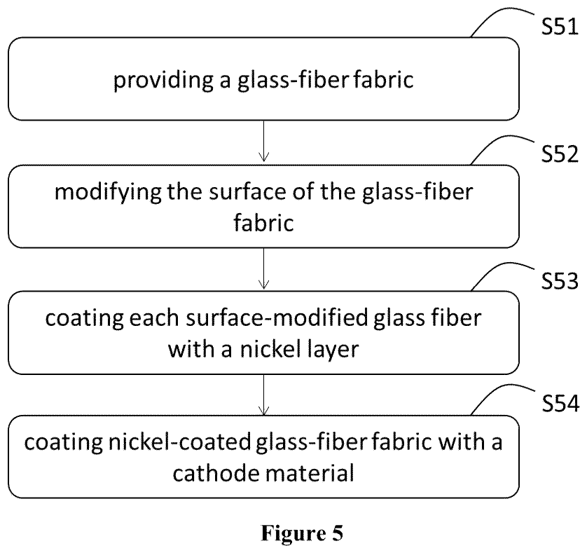

FIG. 5 is a flow chart depicting a method for fabricating a cathode according to certain embodiments. The current collector of the cathode is a nickel-coated glass-fiber fabric. In step S51, a glass-fiber fabric comprising glass fibers is provided. In step S52, the surface of each glass fiber is modified with PMETAC brushes loaded with Pd metal (e.g., Pd particles) thereby forming a surface-modified glass-fiber fabric with surface-modified glass fibers. In step S53, each surface-modified glass fiber is coated with a nickel layer thereby forming a nickel-coated glass-fiber fabric with nickel-coated glass fibers. In step S54, the nickel-coated glass-fiber fabric is further coated with a cathode material thereby forming the cathode.

In certain embodiments, the glass-fiber fabric has a thickness between 30 μm and 100 μm, and a mass density between 3 mg/cm² and 12 mg/cm²; each surface-modified glass fiber is coated with the nickel layer by electroless deposition; the metal-coated glass-fiber fabric has a thickness between 30 μm and 100 μm and a mass density between 4 mg/cm² and 16 mg/cm².

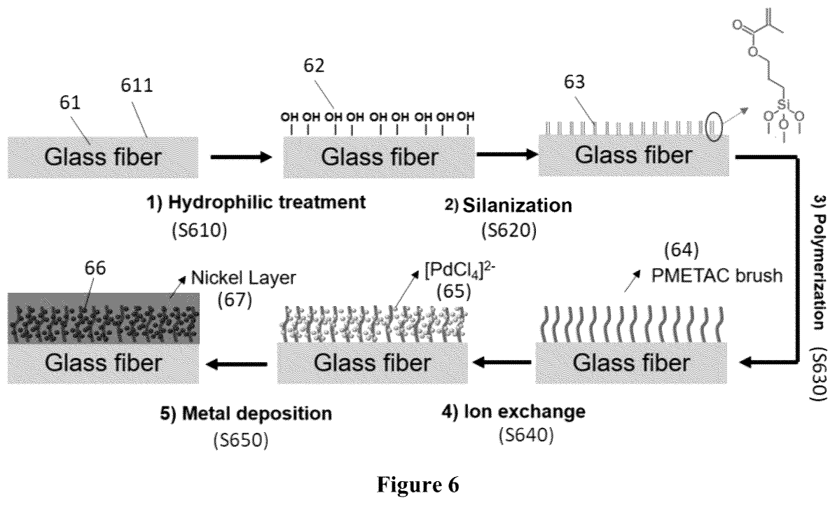

FIG. 6 is a schematic diagram depicting a method for fabricating a metal-coated glass-fiber fabric for a cathode according to certain embodiments. In step S610, a hydroxyl (OH) group 62 is introduced on a glass fiber 61 by plasma treatment thereby forming a plasma-treated glass fiber. In step S620, the surface of the plasma-treated glass fiber is modified with double-bond-containing silane molecules 63 by silanization thereby forming a silanized glass fiber. In step S630, the silanized glass fiber is coated with PMETAC brushes 64 by in-situ polymerization thereby forming a PMETAC-coated glass fiber. This polymerization process ensures the good adhesion between glass fiber 61 and a nickel layer 67 to be coated. In step S640, tetrachloropalladate ions ([PdCl₄]²⁻) 65 are loaded to the PMETAC brushes 64 by ion exchange thereby forming a [PdCl₄]²⁻-load glass fiber. The [PdCl₄]²⁻ loading process makes sure the existence of reduction catalyst for metal deposition. In step S650, the [PdCl₄]²⁻ 65 are reduced to Pd particles 66 (i.e., a catalyst) thereby forming a Pd-loaded glass fiber, and the Pd-load glass fiber is coated with a nickel layer 67 by metal deposition such that the PMETAC brushes 64 loaded with Pd metal 66 are embedded in the nickel layer 67 and the nickel layer 67 is in contact with the surface 611 of glass fiber 61 for providing better adhesion and conductivity, thereby forming a nickel-coated glass-fiber fabric. The nickel layer 67 can make the glass-fiber fabric be conductive and keep electrochemical stable under high potential.

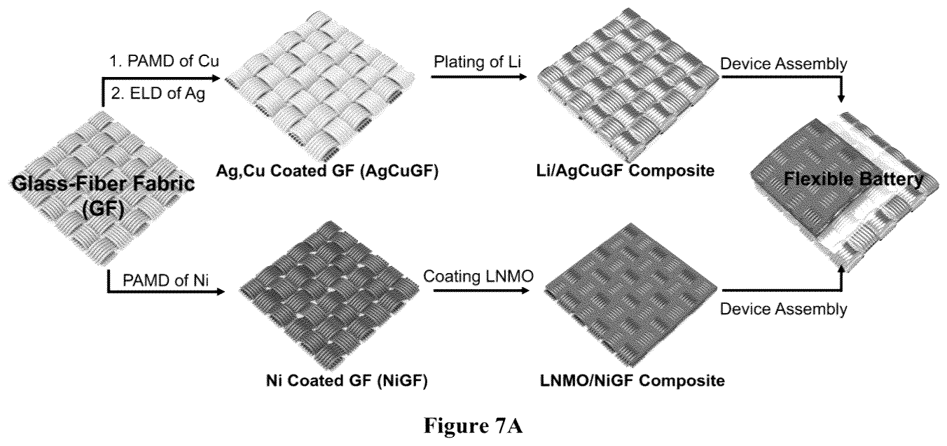

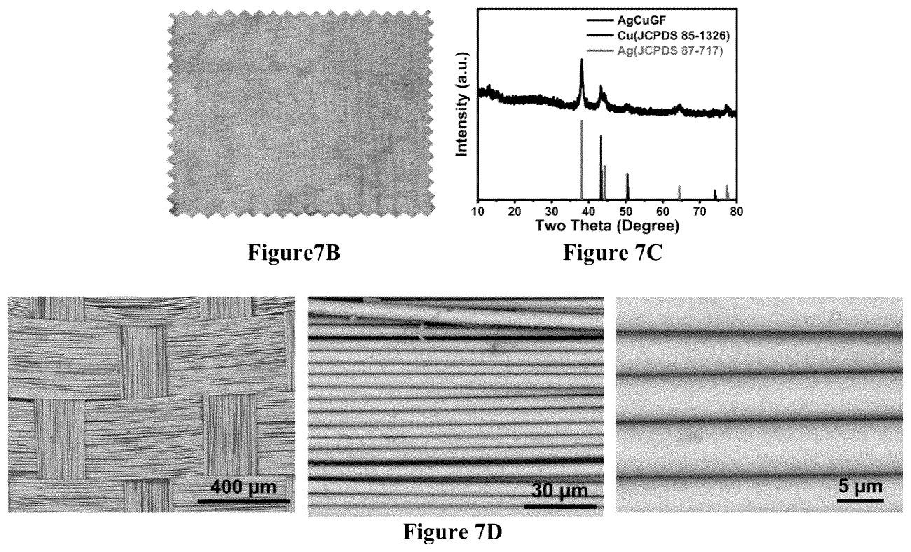

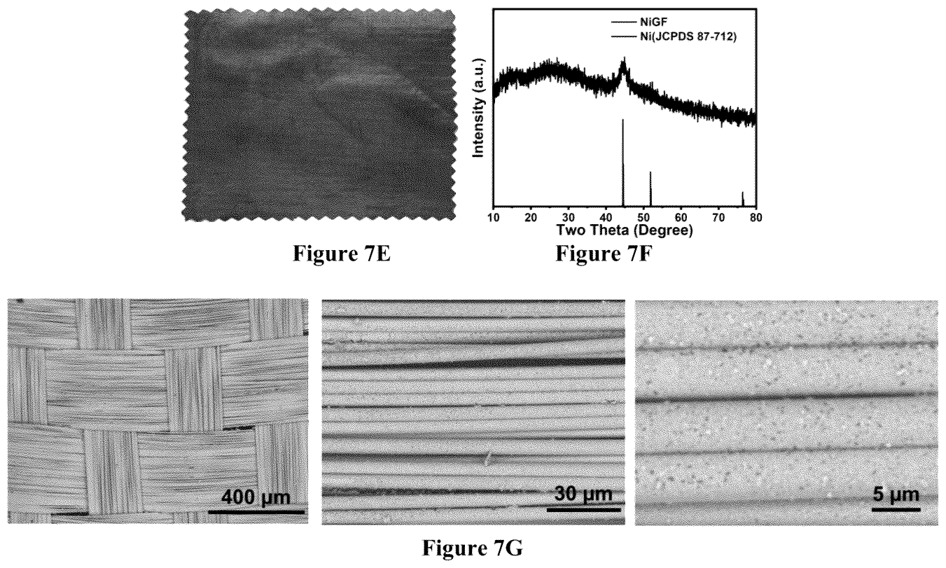

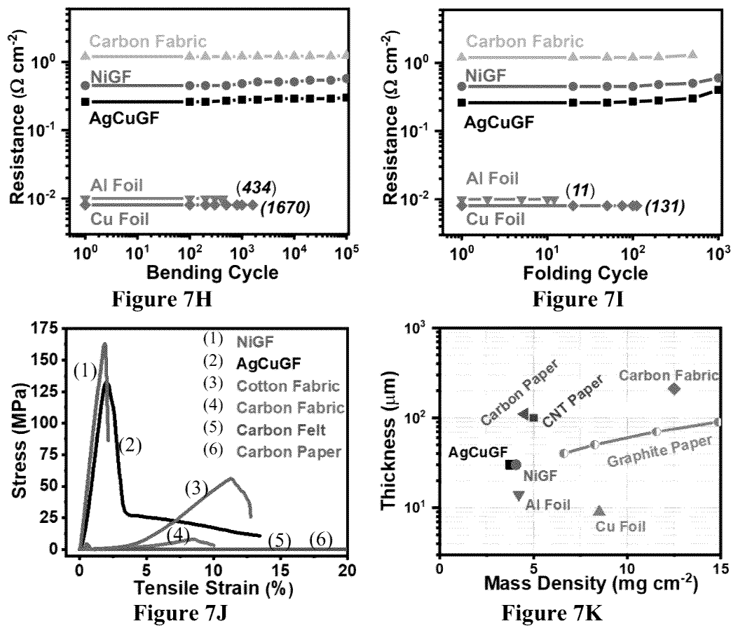

In certain embodiments, chemical-stable glass-fiber fabric with thickness of 30 μm and mass density of 3.0 mg cm⁻² is chosen as soft substrate, and metals are uniformly coated on glass-fiber fabric to make it conductive. Silver and copper co-coated glass fiber fabric (AgCuGF), nickel coated glass-fiber fabric (NiGF) made through polymer-assisted metal deposition (PAMD) method are used as anode and cathode current collectors for respectively fabricating soft composite anode and cathode, followed by assembling and packaging to obtain flexible LBs (FIG. 7A). The metal-coated glass-fiber fabric (AgCuGF and NiGF) exhibit great flexibility, which can be bended for 100,000 bending cycles at a small bending radius of 2 mm and folded for 1,000 times. Moreover, the metal-coated glass-fiber fabrics (AgCuGF and NiGF) possess a mass density of ˜4.0 mg cm⁻², which is lighter than both widely used soft current collectors (e.g., carbon cloth, CNT papers, and carbon felts) and commercial Li-ion battery used metal foils (e.g., Cu foil with thickness of 9 μm and mass density of 8.5 mg cm⁻²) (Table 1). Therefore, the flexible LBs made of these GF based current collectors simultaneously deliver excellent flexibilities and high energy density.

TABLE 1
Comparison of commonly used soft substrates for flexible lithium batteries.

| Current | Density | Thickness | Sheet Resistance | | Tensile | |
|---|---|---|---|---|---|---|
| Collectors | (mg cm⁻²) | (μm) | (Ω cm⁻²) | Structure | Strength | Flexibility |
| AgCuGF | 4.0 | 30 | 0.26 | Plain | High | Excellent |
| | | | | Weaving | | |
| NiGF | 4.1 | 30 | 0.45 | Plain | High | Excellent |
| | | | | Weaving | | |
| Cu Foil | 8.5 | 9 | <0.01 | Metal Foil | Low | Bad |
| Al Foil | 4.2 | 14 | <0.01 | Metal Foil | Low | Bad |
| Carbon | 12.5 | 210 | 1.22 | Plain | Medium | Good |
| Cloth | | | | Weaving | | |
| CNT | ~5 | 160 | 1.05 | Nonwoven | Low | Good |
| Paper | | | | | | |
| Graphene | 2~20 | 10~100 | 0.04 | Nonwoven | Low | Good |
| Paper | | | | | | |
| Graphite | >10 | 100 | 0.04 | Nonwoven | Low | Bad |
| Paper | | | | | | |
| Carbon | >6 | ~100 | 2.5 | Nonwoven | Low | Moderate |
| Felt | | | | | | |

In certain embodiments, Li-Metal composite anode (Li/AgCuGF) and LiNi_{0.5}Mn_{1.5}O₄ (LNMO) composite cathode (LNMO/NiGF) are prepared by electroplating Li on AgCuGF and coating LNMO on NiGF, respectively, followed by assembling and packaging. The flexible LB of Li/AgCuGFllLNMO/GF shows remarkable energy density of 253 Wh kg⁻¹ and 482 Wh L⁻¹, excellent cycle life, and excellent mechanical flexibility, which exceed those of reported flexible LBs. Additionally, as the mass density of AgCuGF is only 47% of that of commercial used Cu foil, when paring Li/AgCuGF with commercial rigid cathodes including LiNi_{0.5}Co_{0.2}Mn_{0.3}O₂ (NCM532), LiFePO₄ (LFP) and LiCoO₂ (LCO) on Al foil, the rigid-type LBs deliver an improvement of 35˜52% in specific energy compared with lithium-ion batteries using graphite/Cu as anode, and an improvement of 10˜19% in specific energy compared lithium mental batteries using Li/Cu as anode. More importantly, the AgCuGF and NiGF are all fabricated with low-cost materials and scale-up fabrication, endowing great possibilities in practical applications in both flexible and rigid-type battery industry.

The fabrication of GF based current collectors, composite electrodes and flexible LBs are illustrated in FIG. 7. In certain embodiments, a vacuum-plasma treated hydrophilic GF was firstly coated with metals through PAMD method. After PAMD process, a thin layer of metals was uniformly coated on each fiber in GF (FIGS. 7B-7G), and both the prepared AgCuGF for anode current collector and NiGF for cathode current collector exhibit low resistances (0.26 Ωcm⁻² for AgCuGF and 0.45 Ωcm⁻² for NiGF) and great mechanical flexibilities. After 100,000 bending cycles at radius of 2 mm and 1,000 folding cycles, no significant resistance change is observed (FIGS. 7H and 7I). Additionally, AgCuGF and NiGF exhibit excellent mechanical strength, the max stresses of AgCuGF and NiGF reach as high as 163 Mpa and 132 Mpa, respectively, which are much higher than the requirements of electrode-fabrication process and wear-resistant applications (FIG. 7J). Furthermore, these GF based current collectors are thinner than most reported soft substrates, and lighter than both soft substrates and metal foils (FIG. 7K). The light weight and thin thickness will great decrease the weight and volume of current collectors in LBs, representing higher energy density in device level.

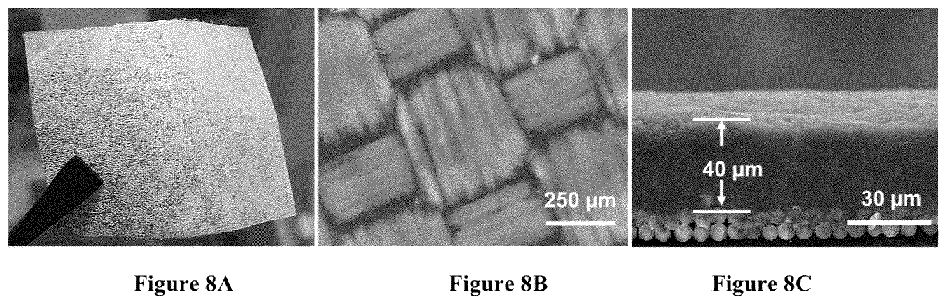

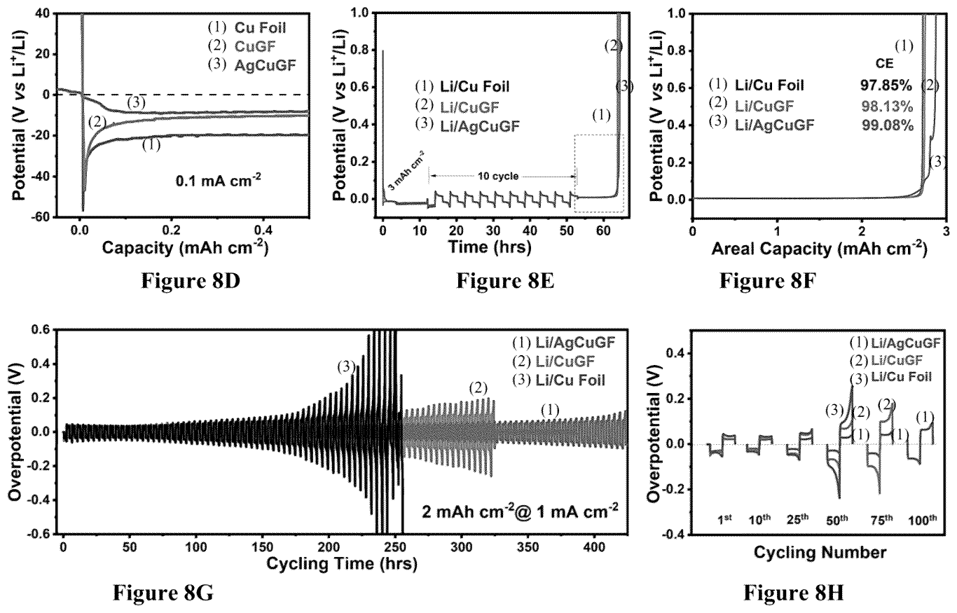

Subsequent to fabricating and characterizing the GF based current collectors, lithium composite anode (Li/AgCuGF) was prepared though electroplating methods. As shown in digital images and scanning electron microscopy (SEM) images, the lithium metal was uniformly and densely coated on yarns and filled the gap between yarns (FIGS. 8A-8C). In the electroplating process, AgCuGF shows an essentially zero nucleation overpotential (V_{nec}, reflected from the sharp tip curves in the deposition potential curves), and much lower mass-transfer potential (Vₘₐₛₛ, reflected from the steady curves), indicating the highly lithiophilic properties of AgCuGF (FIG. 8D). The advanced lithium plating characteristics enable the high coulombic efficiency (CE) of Li during lithium striping/plating process. Then, the average CE of Li/AgCuGF is calculated through the Aurbach's method. After the capacity of 3 mAh cm⁻² of lithium metal was uniformly plated on AgCuGF, a continuous (10 cycles) plating and striping of lithium (1 mAh cm⁻²) was applied, followed by fully striping lithium on AgCuGF and calculating the average CE. The calculated CE of lithium metal on AgCuGF is 99.08%, which is much higher than that on CuGF and Cu foil (FIGS. 8E and 8F). The higher CE indicate that the AgCuGF can prevent the side reaction of lithium with electrolyte and current collectors, endowing longer cycle stability.

To accurately evaluate the cycling stabilities and understand the electrochemical plating/striping mechanism of Li metal anodes, symmetric cell made of Li/AgCuGF with areal capacity of 6 mAh cm⁻² are charged and discharged in an areal capacity of 2 mAh cm⁻² at a current density of 1 mA cm⁻². As shown in FIGS. 8G and 8H, the overpotential of Li/AgCuGF symmetric cell starts at a very low value of ˜20 mV, increases slowly with the raise of cycling time, and reaches at 70 mV after 400 cycling hours. In comparison, the overpotential of Li/CuGF and Li/Cu also start at low value of 22 mV, but the overpotential sharply increases to more than 100 mV and significant short circuit is observed only after 50 striping/plating cycles, indicating the poor lithium stabilized property. The cycling stabilities of symmetric cells are in accordance with the results of lithium deposition voltage and CE mentioned above.

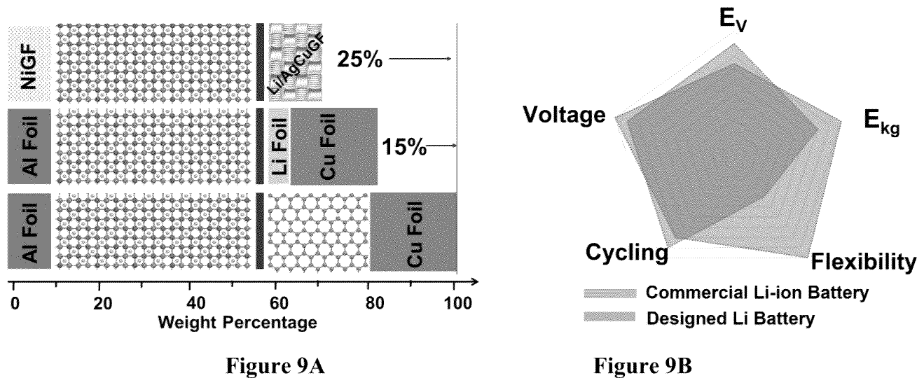

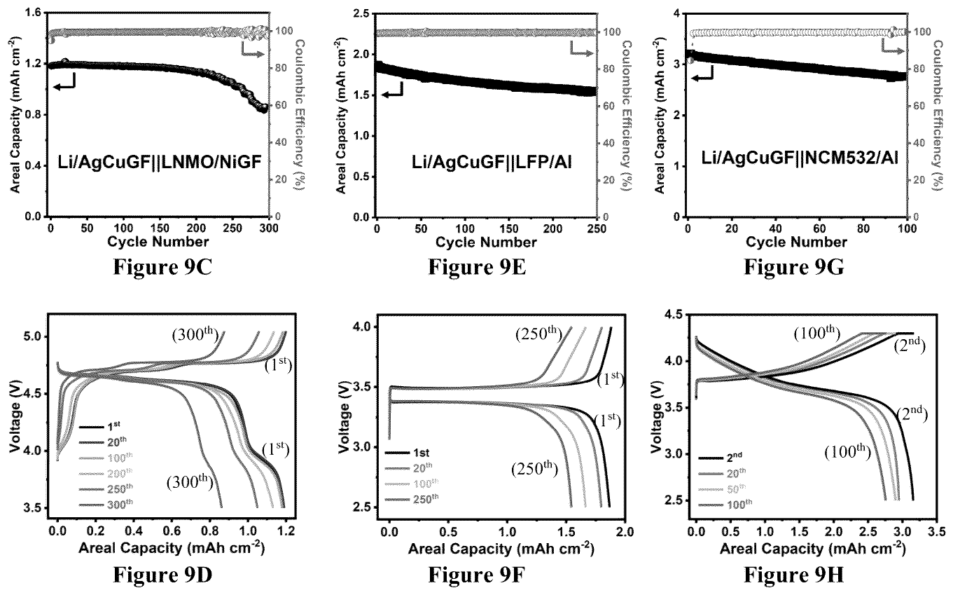

Apart from the excellent electrochemical stability, the Li/AgCuGF anode also shows light weight and good flexibility. For a battery with areal capacity of 3 mAh cm⁻², using Li/AgCuGF as anode with N/P ratio of 3.0 will theoretically reduce the 25% and 13% of total weight (only considering the weight of anode, cathode, and separator) compared with the batteries using Graphite/Cu and Li/Cu as anodes, respectively (FIGS. 9A and 9B). Two sets of LBs are assembled: 1) flexible LBs made of Li/AgCuGF and LNMO/NiGF and 2) rigid-type LBs made of Li/AgCuGF and commercial cathode using Al foil as current collector. As shown in FIGS. 9C and 9D, the flexible LBs of Li/AgCuGFllLNMO/NiGF shows discharge voltage of 4.7 V and areal capacity of 1.2 mAh cm⁻². After 250 charging/discharging cycles at 1 C, the full battery retains 87.5% of its initial capacity, suggesting its good stability with a long cycle life. The flexible Li/AgCuGFllLNMO/NiGF battery delivers a gravimetric energy density of 253 Wh kg⁻¹, and a volumetric energy density of 482 Wh L⁻¹, which are superior to those of reported flexible LBs using current collectors of graphite papers, carbon fabrics, metal coated carbon fabrics, metal foils and stainless-steel mesh (Table 2).

TABLE 2
Comparison of our flexible lithium metal battery fabrics with
some best-performed flexible batteries reported in literatures.

| | | | | | Eᵥₒₗ | E_{g} |
|---|---|---|---|---|---|---|
| Device | Type | Current Collector | Capacity | | (Wh L⁻¹) | (Wh kg⁻¹) |
| Li/AgCuGF//LNMO/NiGF | LMB | AgCuGF, NiGF | 1.2 | mAh cm⁻² | 482 | 253 |
| PGF/PGF-LNMO ^{a)} | LIB | Graphite Film | NA | | NA | 252 |
| Li/CuCF//NSHG/S8/NiCF ^{b)} | LMB | CFs | 3 | mAh cm⁻² | 360 | 288 |
| CC@EC@NCO//CC@EC@NCM ^{c)} | LIB | CFs | 1.86 | mAh cm⁻² | NA | 314 |
| CF/ECF/NiO/CD//CF/ECF/NCM^{d)} | LIB | CFs | 0.9 | mAh cm⁻² | NA | 201.7 |
| Grahite//LiCoO₂ Spine-like Battery | LIB | Metal Foil | 151 | mAh g⁻¹ | 242 | NA |
| | | | 63.9 | mAh cm⁻³ | | |
| Soft LiTi₂(PO₄)₃//Li_{1.1}Mn₂O₄ | LIB | Stainless Steel Mesh | 37 | mAh g⁻¹ | 124 | 63 |

where
^{a)} “PGF” represents “porous graphite foil”,
^{b)} “CuCF” and “NiCF” represent “Cu coated carbon farbic” and “Ni coated carbon farbic”,
^{c)} “CC@EC” represents “carbon cloth coated exfoliated pourous carbon shell”, “NCO” represents “NiCo₂O₄”,
^{d)}“CF/ECF” represents “exfoliated porous N-doped carbon fiber”, “CD” represents “carbon quantum dots”. The energy densities above are calculated based on the total weigh or thickness of electrodes including the current collectors, active materials, binders, and carbon black.

For rigid-type LBs made of Li/AgCuGF and commercial cathode, Li/AgCuGF anode is paired with NCM532, LCO and LFP cathodes. These rigid-type LBs deliver higher areal capacities and good cycling stabilities. For example, the areal capacity of Li/AgCuGFllLFP/Al is 1.8 mAh cm⁻², and only 17.2% performance decay after 250 charging and discharging cycles. The areal capacity of Li/AgCuGFllNCM532/Al reaches 3.2 mAh cm⁻², and a very small capacity decay of 13% is observed after 100^{th} charging/discharging cycles at 0.33 C. Then the gravimetric and volumetric energy density are calculated only consideration of the weight of electrodes and separator. The energy densities of Li/AgCuGFllLFP/Al and Li/AgCuGFllNCM532/Al are 222 Wh kg⁻¹ and 353 Wh kg⁻¹, respectively (FIGS. 9E-9H). These energy densities are compared with that of lithium-ion batteries using graphite/Cu anode and lithium metal battery using Li/Cu as anode, an improvement of 35˜52% in specific energy compared with lithium-ion batteries, and an improvement of 10˜19% in specific energy compared lithium mental batteries using Li/Cu as anode (Table 3).

TABLE 3
Comparison of rigid-type lithium metal batteries using Li/AgCuGF
anodes with lithium metal batteries using Li/Cu foil anodes and
commercial lithium-ion battery using Graphite/Cu foil anodes.

| | Anode | Separator | | | E_{g} | Improvement | |
|---|---|---|---|---|---|---|---|
| Battery Type | (mg cm⁻²) | (mg cm⁻²) | Cathode | | (Wh kg⁻¹) | (%) | |
| Li/AgCuGF∥NCM/Al | 6.5 | 1.0 | 23.4 | mg cm⁻² | 353 | 35 | 11 |
| Li/Cu∥NCM/Al | 11.0 | | ~3.2 | mAh cm⁻² | 316 | 17 | NA |
| Graphite/Cu∥NCM/Al | 18.5 | | | | 269 | NA | NA |
| Li/AgCuGF∥LFP/Al | 5.3 | 1.0 | 16.4 | mg cm⁻² | 222 | 52 | 9.9 |
| Li/Cu∥LFP/Al | 9.8 | | ~1.8 | mAh cm⁻² | 202 | 38 | NA |
| Graphite/Cu∥LFP/Al | 13.5 | | | | 146 | NA | NA |
| Li/AgCuGF∥LCO/Al | 6.0 | 1.0 | 17.3 | mg cm⁻² | 449 | 46 | 19 |
| Li/Cu∥LCO/Al | 10.5 | | ~2.6 | mAh cm⁻² | 378 | 23 | NA |
| Graphite/Cu∥LCO/Al | 17.1 | | | | 308 | NA | NA |

where all the energy densities in table above are calculated based on the total weight of electrodes including the current collectors, active materials, binders, and carbon black.

These significant improvements endow the potential applications of superlight GF-based current collectors in both flexible and rigid-type battery industry.

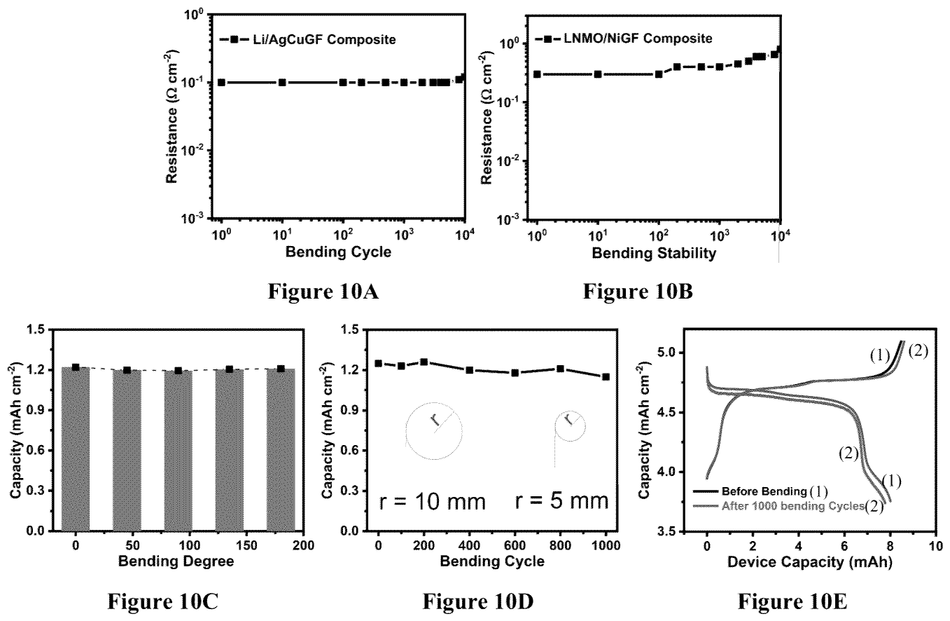

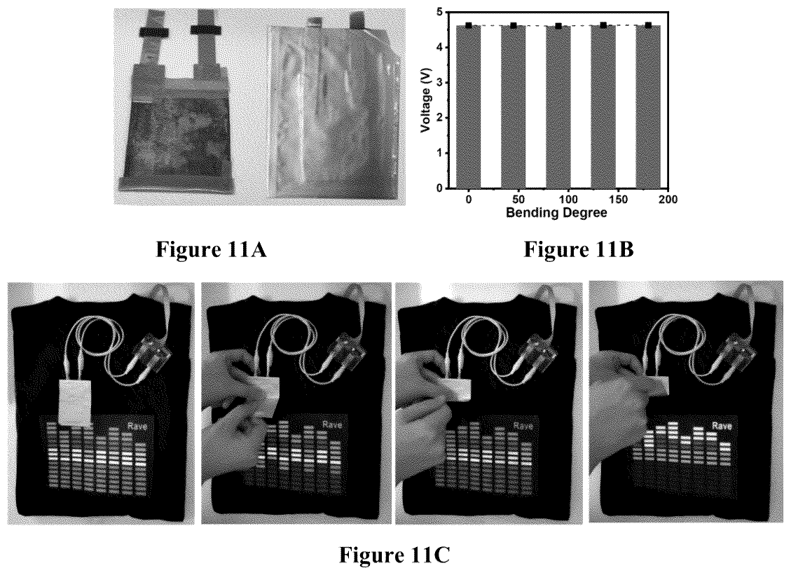

Besides the high energy density, the GF-based LBs also exhibit outstanding flexibilities, which are suitable for wearable applications. First of all, structural stability of GF-based electrodes (Li/AgCuGF and LNMO/NiGF) are tested by continuously bending. After 10,000 bending at a radius of 2 mm, the resistance does not show significant increase (FIGS. 10A and 10B), indicating GF-based electrodes are highly suitable for making high energy flexible LBs. Secondly, the flexible FBs are fabricated by stacking Li/AgCuGF anode and LNMO/NiGF cathode with a celgard 2500 separator, followed by adding electrolyte and encapsulating with commercially available Al-plastic film. After assembly, the flexible LBs are bended at different bending angels (0°, 45°, 90°, 135°, and 180°), and tested the areal capacity. As shown in FIG. 10C, the capacity does not show noticeable change when the device was bent to different angles. Finally, continuous bending was applied to the flexible LBs to simulate the daily use. After more than 1,000 bending cycles at radius of 10 mm and 5 mm, the flexible LBs still maintain its original electrochemical energy storage performance. Only an 8% capacity decay is observed form the charge and discharge profile (FIGS. 10D and 10E), indicating the great flexibility.

Benefit from the high energy density and great flexibility, the Li/AgCuGFllLNMO/NiGF is suitable for flexible and wearable applications. To demonstrate the capability, a flexible LB with areal of 3×4 cm² can power LED garment for several minutes even under different bending degrees (FIGS. 11A-11C). The LED garment keeps lighting with stable brightness during continuous bending at small radius.

Accordingly, this embodiment provides a new soft substrate for energy-dense flexible lithium metal battery. The well-designed AgCuGF current collector not merely shows superlight weight, ultrathin thickness, and great mechanical flexibility, but also exhibits great guidance of lithium nucleation and deposition, representing significant Li stabilization properties. These properties provide the soft lithium metal anode (Li/AgCuGF) with excellent flexibility and remarkable CE of 99.08%. On the cathode side, NiGF current collectors provide large surface area for coating commercial cathode materials, enabling excellent flexibilities. As a result, the flexible battery of Li/AgCuGFllLNMO/NiGF deliver ultrahigh gravimetric energy density of 253 Wh kg⁻¹, great cycling stabilities and excellent flexibilities. This energy density performance exceeds those flexible batteries using thick conductive substrate including carbon fabric, carbon papers, et. al. Moreover, as the weight of AgCuGF current collector is only 47% of Cu foil used in rigid LBs, the rigid-type batteries made of Li/AgCuGF and commercial cathode show improvements of 35˜52% and 10˜19% in specific energy compared with lithium-ion batteries using graphite/Cu as anode, and lithium metal batteries using Li/Cu as anode, respectively (Table 3).

These improvements provide great potential in practical application in both flexible and rigid-type batteries. In principle, this new design of glass-fiber current collectors can be also applied for other flexible energy storage electronics (e.g., supercapacitors, lithium-ion batteries, sodium batteries, zinc batteries, et al.), energy harvesting electronics (e.g., nanogenerators, textile-based solar cell, et al.), and catalysis area.

### Example 1: Preparation of Ag, Cu Co-Coated Glass-Fiber Fabrics (AgCuGF)

The commercially available GF (with thickness of 30 μm and mass-density of 3 mg cm⁻²) were placed into the vacuum plasma chamber and treated for 30 mins. Then, the plasma-treated GF were rinsed by deionized (D.I.) water and dried at 60° C. for 1 hr, followed by four steps PAMD coating. Typically, the treated GF was put into the 4% (v/v) [3-(methacryloyloxy) propyl] trimethoxysilane in 95% EtOH, 1% acetic acid and 4% deionized water solution for 1 hr at room temperature. Then the silanized GF were immersed in a mixture of poly[2-(methacryloyloxy)ethyl]trimethyl ammonium chloride (PMETAC) (20% v/v in water) and potassium persulfate (2 g L⁻¹), followed by polymerization at 80° C. for 1 hr. After that, PMETAC-coated fabrics were dipped into a 5 mM (NH₄)₂PdCl₄ solution for 30 min for ion exchange reaction for coating [PdCl₄]²⁻ catalyst. At last, [PdCl₄]²⁻ loaded GF were put into electroless deposition bath of Cu for a 30 min to electroless deposition Cu. The deposition of Cu was conducted in a plating bath, which was mixing solution A and Solution B. Solution A contains NaOH (12 g L⁻¹), CuSO₄·5H₂O (13 g L⁻¹), and KNaC₄H₄O₆·4H₂O (29 g L⁻¹) in D.I. water. Solution B is a formaldehyde (HCHO, 9.5 mL L⁻¹) aqueous solution. After coating of thin layer Cu, the CuGF were put into the deposition bath of Ag for 10 min to electroless deposition a thin layer Ag on CuGF. The plating is prepared by dropwise adding B solution into solution A. Solution A consists of glucose (C₆H₁₂O₆, 45 g L⁻¹), potassium sodium tartrate (5 g L⁻¹), ethyl alcohol (100 mL L⁻¹) in DI water. Solution B consists of AgNO₃ (30 g L⁻¹), 25% of NH₃·H₂O (200 mL L⁻¹) and NaOH (24 g L⁻¹) in D.I. water.

### Example 2: Preparation of Ni-Coated Glass Fiber Fabrics (NiGF)

The NiGF was prepared by PAMD process. The [PdCl₄]²⁻ loaded GF was put into electroless deposition bath of Ni for a 30 min to electroless deposition Ni. The plating bath is prepared by slowly adding B solution into solution A. Solution A consists of Ni₂SO₄·5H₂O (40 g L⁻¹), sodium citrate (20 g L⁻¹), lactic acid (10 g L⁻¹) in DI water. Solution B is the dimethylamine borane (DMAB) (1 g L⁻¹) in D.I. water.

### Example 3: Preparation of Lithium Composite Anode (Li/AgCuGF)

The Li/AgCuGF were prepared through an electrodeposition process. Typically, a 2032-coin cell was assembled with lithium foil as anode, conductive fabric as cathode, celgard 2500 as separator. The commercial electrode is used, which is 1M lithium bis(trifluoromethanesulfonyl)imide (LiTFSI) in a mixture solution of 1,3-dioxolane (DOL) and 1,2-dimethoxyethane (DME) (1:1, v/v) with 2 wt % LiNO₃ additives. Then, the cell was firstly charge and discharged 0.1 mAh cm⁻² at 0.1 mA cm⁻² for 2 cycles to clean the surface. The electroplating then conducted by discharge the cell at 0.5 mA cm⁻² for 12 hrs to obtain Li deposited conductive fabrics. Through turning the discharging hours, different areal capacity of Li/AgCuGF were obtained.

### Example 4: Preparation of Flexible Cathodes

The flexible cathodes were fabricated through doctor-blading coating method.

Typically, the commercially available cathode materials, including lithium manganese oxide (LMO), lithium iron phosphate (LFP), LiNi_{0.5}Mn_{1.5}O₄ (LNMO) or lithium nickel cobalt manganese oxide (NCM) or lithium nickel cobalt aluminum oxides (NCA) or Lithium cobalt oxide (LCO) or sulfur (S).) were mixed with acetylene black and polyvinylidene difluoride (PVDF) in mass ratio of 8:1:1 in an agate mortar, followed by adding specific amount of N-Methyl-2-pyrrolidone (NMP). Then, heavily mix to obtain homogeneous slurry. After that, the mixture slurry is coated on NiGF. Then, the electrode is vacuum dried to remove the solvent.

### Example 5: Device Assembly

The lithium battery was encapsulated with commercially available Al-plastic film (12 μm) in an argon-filled glove box by using Li-metal fabric anodes, celgard 2500 separator, and prepared soft cathode. The electrolyte of 1M LiTFSI in DOL/DME (1:1. v/v) with 2 wt % LiNO₃ was used in Li/AgCuGFllLFP/Al battery system, and the electrolyte of 1M LiPF₆ in DEC/FEC (7:3, v/v) was used for Li/AgCuGFllNCM532/Al, Li/AgCuGFllLNMO/NiGF battery systems.

### Example 6: Anode Formation and CE Calculation

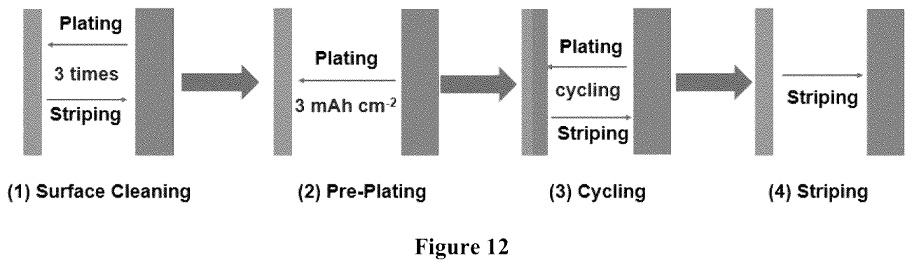

As shown in FIG. 12, the substrate was first plating and striping a small amount of lithium at low current density to remove the side reaction between lithium and substrate surface. Then, the capacity of 3 mAh cm⁻² of lithium was deposited on the substrate at current density of 0.25 mA cm⁻². After that a continuous (10 cycles) plating and striping of 1 mAh cm⁻² at current density of 0.5 mA cm⁻² was applied. At last, the lithium on anode side were fully striped at current density of 0.25 mA cm⁻², the average CE could be calculated form the equation.

CE=Cₛ+N*C_{cycle}/Cₚ+N·C_{cycle}

where Cₚ, Cₛ, C_{cycling} and N represent the capacity of pre-plated lithium, last striped lithium and capacity of each continuous cycling, and cycling numbers.

The morphology and structure of the as-prepared samples were fully characterized by field-emission scanning electron microscope (FESEM, JEOL, JSM-7600F), powder X-ray diffraction (XRD, Rangaku Smart Lab 9 kW, Cu Kα, λ=1.5406 Å) and X-ray photoelectron spectroscopy (XPS, Thermo ESCALAB 250). The electrochemical characterizations, such as cyclic voltammetry (CV) curves, galvanostatic charge/discharge (GCD) curves, electrochemical impedance spectroscopy (EIS) tests were performed on a CHI600e electrochemical workstation and neware battery test system.

Although the invention has been described in terms of certain embodiments, other embodiments apparent to those of ordinary skill in the art are also within the scope of this invention. Accordingly, the scope of the invention is intended to be defined only by the claims which follow.

What is claimed is:

1. A current collector for an anode comprising:
a metal-coated glass-fiber fabric comprising metal-coated glass fibers, each metal-coated glass fiber comprising:
a surface-modified glass fiber comprising a glass fiber, poly[2-(methacryloyloxy)ethyl]trimethyl ammonium chloride (PMETAC) brushes and palladium (Pd) metal, wherein the PMETAC brushes are loaded with the palladium metal and coated on a surface of the glass fiber; and
a first metal layer coated on the surface-modified glass fiber such that the PMETAC brushes loaded with the palladium metal are embedded in the first metal layer and the first metal layer is in contact with the surface of the glass fiber, the first metal layer being a copper layer, a silver layer or a gold layer.

2. The current collector of claim 1, wherein the first metal layer is a copper layer; and the metal-coated glass-fiber fabric further comprises a second metal layer coated on the copper layer such that the copper layer is sandwiched between the second metal layer and the glass fiber, the second metal layer being a silver layer or a gold layer.

3. The current collector of claim 1, wherein the first metal layer is a silver layer; and the metal-coated glass-fiber fabric further comprises a gold layer coated on the silver layer such that the silver layer is sandwiched between the gold layer and the glass fiber.

4. The current collector of claim 1, wherein the first metal layer has a thickness between 50 nm and 500 nm.

5. The current collector of claim 2, wherein the second metal layer has a thickness between 20 nm and 50 nm.

6. The current collector of claim 1, wherein the metal-coated glass-fiber fabric has a plain weaving structure, a thickness between 30 μm and 100 μm, and a mass density between 4 mg/cm² and 15 mg/cm²; and the glass fiber comprises silica and aluminum oxide and has a diameter between 0.1 μm and 30 μm.

7. A method for fabricating the metal-coated glass-fiber fabric of the current collector of claim 1 comprising:
providing a glass-fiber fabric comprising glass fibers;
introducing a hydroxyl (OH) group on each glass fiber by plasma treatment thereby forming plasma-treated glass fibers;
modifying the surface of each plasma-treated glass fiber with double-bond-containing silane molecules by silanization thereby forming silanized glass fibers;
coating each silanized glass fiber with PMETAC brushes by in-situ polymerization thereby forming PMETAC-coated glass fibers;
loading tetrachloropalladate ions ([PdCl₄]²⁻) to the PMETAC brushes by ion exchange thereby forming [PdCl₄]²⁻-load glass fibers;
reducing the [PdCl₄]²⁻ to Pd metal thereby forming Pd-loaded glass fibers; and
coating each Pd-load glass fiber with a first metal layer by electroless deposition thereby forming the metal-coated glass fibers, the first metal layer being a copper layer, a silver layer, or a gold layer.

8. A method for fabricating the metal-coated glass-fiber fabric of the current collector of claim 2 comprising:
providing a glass-fiber fabric comprising glass fibers;
introducing a hydroxyl (OH) group on each glass fiber by plasma treatment thereby forming plasma-treated glass fibers;
modifying the surface of each plasma-treated glass fiber with double-bond-containing silane molecules by silanization thereby forming silanized glass fibers;
coating each silanized glass fiber with PMETAC brushes by in-situ polymerization thereby forming PMETAC-coated glass fibers;
loading tetrachloropalladate ions ([PdCl₄]²⁻) to the PMETAC brushes by ion exchange thereby forming [PdCl₄]²⁻-load glass fibers;
reducing the [PdCl₄]²⁻ to Pd metal thereby forming Pd-loaded glass fibers;
coating each Pd-load glass fiber with a copper metal layer by electroless deposition thereby forming the copper-coated glass fibers; and
coating each copper-coated glass fiber with a silver layer or a gold layer thereby forming the metal-coated glass-fiber fabric.

9. A flexible anode comprising the current collector of claim 1 and an anode material coated on the metal-coated glass-fiber fabric.

10. The flexible anode of claim 9, wherein the anode material is lithium, natural graphite, artificial graphite, hard carbon, silicon, a silicon and carbon composite, or lithium titanate (Li₄Ti₅O₁₂).

11. A flexible anode comprising the current collector of claim 2 and an anode material coated on the metal-coated glass-fiber fabric.

12. A current collector for a cathode comprising:
a metal-coated glass-fiber fabric comprising metal-coated glass fibers, each metal-coated glass fiber comprising:
a surface-modified glass fiber comprising a glass fiber, poly[2-(methacryloyloxy)ethyl]trimethyl ammonium chloride (PMETAC) brushes and palladium metal, wherein the PMETAC brushes are loaded with the palladium metal and coated on the surface of the glass fiber; and
a metal layer coated on the modified surface of the surface-modified glass fiber such that the PMETAC brushes loaded with the palladium metal are embedded in the metal layer and the metal layer is in contact with a surface of the glass fiber, the metal layer being a nickel layer, an aluminum layer or a titanium layer.

13. The current collector of claim 12, wherein the metal layer has a thickness between 100 nm and 500 nm.

14. The current collector of claim 12, wherein the metal-coated glass-fiber fabric has a plain weaving structure, a thickness between 30 μm and 100 μm, and a mass density between 4 mg/cm² and 16 mg/cm²; and the glass fiber comprises silica and aluminum oxide and has a diameter between 0.1 μm and 30 μm.

15. A method for fabricating the metal-coated glass-fiber fabric of the current collector of claim 12 comprising:
providing a glass-fiber fabric comprising glass fibers;
introducing a hydroxyl (OH) group on each glass fiber by plasma treatment thereby forming plasma-treated glass fibers;
modifying the surface of each plasma-treated glass fiber with double-bond-containing silane molecules by silanization thereby forming silanized glass fibers;
coating each silanized glass fiber with PMETAC brushes by in-situ polymerization thereby forming PMETAC-coated glass fibers;
loading tetrachloropalladate ions ([PdCl₄]²⁻) to the PMETAC brushes by ion exchange thereby forming [PdCl₄]²⁻-load glass fibers;
reducing the [PdCl₄]²⁻ to Pd metal thereby forming Pd-loaded glass fibers; and
coating each Pd-load glass fiber with a metal layer by electroless deposition thereby forming the metal-coated glass-fiber fabric, the metal layer is a nickel layer, an aluminum layer or a titanium layer.

16. The method of claim of claim 15, wherein the glass-fiber fabric has a thickness between 30 μm and 100 μm, and a mass density between 3 mg/cm² and 12 mg/cm²; and the metal-coated glass-fiber fabric has a mass density between 4 mg/cm² and 16 mg/cm².

17. A flexible cathode comprising the current collector of claim 12 and a cathode material coated on the metal-coated glass-fiber fabric.

18. The flexible cathode of claim 17, wherein the cathode material is lithium manganese oxide (LMO), lithium iron phosphate (LFP), LiNi_{0.5}Mn_{1.5}O₄ (LNMO), lithium nickel cobalt manganese oxide (NCM), lithium nickel cobalt aluminum oxides (NCA), Lithium cobalt oxide (LCO) or sulfur (S).

19. A flexible battery comprising:
the flexible anode of claim 11;
a flexible cathode comprising a cathode material and a metal-coated glass-fiber fabric comprising metal-coated glass fibers, each metal-coated glass fiber comprising:
a surface-modified glass fiber comprising a glass fiber, poly[2-(methacryloyloxy)ethyl]trimethyl ammonium chloride (PMETAC) brushes and palladium metal, wherein the PMETAC brushes are loaded with the palladium metal and coated on a surface of the glass fiber; and
a metal layer coated on the modified surface of the surface-modified glass fiber such that the PMETAC brushes loaded with the palladium metal are embedded in the metal layer and the metal layer is in contact with the surface of the glass fiber, the metal layer being a nickel layer, an aluminum layer or a titanium layer;
a separator; and
an electrolyte.

20. The flexible battery of claim 19, wherein the anode material is lithium; the cathode material is LNMO; the separator is a microporous monolayer polypropylene (PP) membrane; and the electrolyte is lithium hexafluorophosphate (LiPF₆) in dimethyl carbonate (DEC) and fluoroethylene carbonate (FEC).
